(19) United States
(12) Patent Application Publication
(10) Pub. No.: US 2021/0198566 A1
(43) Pub. Date: Jul. 1, 2021

(54) FORMULATION

(71) Applicant: Merck Patent GmbH, Darmstadt (DE)

(72) Inventor: Masaki HASEGAWA, Kanagawa (JP)

(73) Assignee: Merck Patent GmbH, Darmstadt (DE)

(21) Appl. No.: 17/057,147

(22) PCT Filed: May 21, 2019
(86) PCT No.: PCT/EP2019/063065

§ 371 Date: Nov. 20, 2020

(30) Foreign Application Priority Data
May 24, 2018 (EP) 18174014.3

(51) Int. Cl. C09K 11/02; C09K 11/88; C09K 11/70

(52) U.S. Cl. CPC C09K 11/025; B82Y 20/00; C09K 11/70; C09K 11/883

(57) ABSTRACT

The present invention relates to a formulation comprising at least a polymer, a particle, and an organic solvent.

### FIELD OF THE INVENTION

The present invention relates to a formulation comprising a first particle, and a process for preparing of said formulation. The present invention further relates to an optical medium, and an optical device. The present invention further relates to use of a formulation.

### BACKGROUND ART

Formulation comprising a nanosized light emitting material is known in the prior art.

For example, US 2008/0277626 A1 discloses an ink formulation comprising Quantum PbS dots, 2-pyrrolidone, glycerol, and water.

U.S. Pat. No. 8,765,014 B2 discloses a quantum dot ink composition for inkjet printing consisting of 0.1 g of CdSe/ZnS nanocrystals with 70 g of chlorobenzene and 24.9 g of cyclohexane, and 5 g of Ttiton X-100.

### Patent Literature

1. US 2008/0277626 A1

2. U.S. Pat. No. 8,765,014 B2

### Non Patent Literature

None

### SUMMARY OF THE INVENTION

However, the inventors newly have found that there is still one or more of considerable problems for which improvement is desired as listed below;

an improved homogeneous layer or pattern after drying of a formulation comprising at least a first particle, preferably said layer or pattern is a light luminescent layer or pattern, preventing or reducing phenomena of moving a first particle to the edge of printed pattern when printing and drying of said formulation, smooth printing of the formulation, better dispersibility of a first particle(s) in said formulation, preferably better dispersibility of scattering particles and/or light emitting particles, simple fabrication process for making a pattern including a polymer and a first particle, preferably said pattern and/or formulation includes a polymer, scattering particles and/or light emitting particles, higher loading of scattering particles and/or light emitting particles in said formulation, or layer or pattern.

The inventors aimed to solve one or more of the problems indicated above.

Then it was found that a novel formulation comprising at least a polymer, a first particle, and

a 1^{st} organic solvent having a boiling point of 150° C. or more.

In another aspect, the invention also relates to a process for preparing of a formulation comprising at least a polymer, a first particle, and a 1^{st} organic solvent having a boiling point of 150° C. or more, wherein the method comprising at least following step (a),

(a) mixing at least a 1^{st} organic solvent having a boiling point of 150° C. or more, a polymer, and a first particle.

In another aspect, the invention further relates to a process for preparing of an optical medium, wherein the process comprises at least following steps (A) and (B),

(A) providing the formulation of the present invention, onto a substrate,

(B) removing the 1st organic solvent from the formulation.

In another aspect, the invention relates to use of the formulation of the present invention, for a device fabrication.

In another aspect, the invention also relates an optical medium comprising at least a substrate, a polymer, and a first particle obtained or obtainable from the process of the present invention, preferably said substrate includes an array of pixels filled with at least a polymer, and a first particle.

In another aspect, the invention further relates to an optical device comprising the optical medium.

Further advantages of the present invention will become evident from the following detailed description.

### DETAILED DESCRIPTION OF THE INVENTION

According to the present invention, said formulation comprising at least a polymer, a first particle, and a 1^{st} organic solvent having a boiling point of 150° C. or more.

According to the present invention, the boiling points of solvents is measured with Dosa Therm 300® from Titan Technologies.

In some embodiments of the present invention, the absolute viscosity of the formulation can be in the range from 1 mPa·s to 20 mPa·s.

The viscosity of the formulations and solvents according to the present invention is measured with VM-10A-L® from SEKONIC.

In a preferred embodiment of the present invention, the formulation comprises a plurality of first particles.

In a preferred embodiment of the present invention, it is in the range from 3 mPa·s to 15 mPa·s. to realize a better printing.

In some embodiments of the present invention, the liquid surface tension of the formulation is in the range from 10 mN/m to 60 mN/m.

According to the present invention, the surface tension measurements can be performed with Pendant Drop method with using DM-501® from Kyowa Interface Science Co., Ltd.

In a preferred embodiment of the present invention, the liquid surface tension of the formulation is in the range from 20 mN/m to 50 mN/m.

### First Particle

In a preferred embodiment of the present invention, said first particle is a light scattering particle or a light emitting particle.

### Light Scattering Particle

As the light scattering particle, any type of publicly known light scattering particles having different refractive index from the polymer of the formulation which includes the said light scattering particles and can give Mie scattering effects, can be used preferably as desired.

For examples, small particles of inorganic oxides such as SiO₂, SnO₂, CuO, CoO, Al₂O₃ TiO₂, Fe₂O₃, Y₂O₃, ZnO, MgO, ZrO₂; organic particles such as polymerized polystyrene, polymerized PMMA; or a combination of any of these; can be used preferably, more preferably ZnO, TiO₂, and/or Al₂O₃.

Preferably, the average particle diameter of the light scattering particles can be in the range from 100 nm to 5 μm, more preferably in the range from 200 nm to 250 nm and/or in the range from 350 nm to 5 μm.

Even more preferably, TiO2 particles having average particle diameter in the range of 200 to 250 nm can be used preferably.

Without wishing to be bound by theory, it is believed that more than 350 nm average particle diameter may lead to strong forward scattering caused by Mie scattering in a later, even if the refractive index difference between the light scattering particles and the layer matrix is as small as 0.1.

On the other hand, to obtain better layer forming properties by using the light scattering particles, maximum average particle diameter is 5 um or less, preferably. More preferably, from 500 nm to 2 μm.

### Light Emitting Material

According to the present invention, as a light emitting material, a wide variety of publicly known light emitting material can be used as desired.

In some embodiments of the present invention, said light emitting material is an organic light emitting material, inorganic light emitting material, preferably said inorganic light emitting material is a nanosized light emitting materials such as a nanosized phosphor, or a quantum material.

A type of shape of the nanosized light emitting material of the present invention is not particularly limited.

Any type of nanosized light emitting material, for examples, spherical shaped, elongated shaped, star shaped, polyhedron shaped semiconductor nanocrystals, can be used in this way.

The term “semiconductor” means a material which has electrical conductivity to a degree between that of a conductor (such as copper) and that of an insulator (such as glass) at room temperature.

As organic light luminescent materials, any kinds of organic fluorescent dyes and/or organic phosphorescent dyes can be used as desired. Such as commercially available laser dyes and/or light emissive dyes used in an organic light emissive diode. For examples, Laser dyes from Indeco Corporation, dyes from American Dye Sources.

In a preferred embodiment of the present invention, as organic light luminescent materials for blue emission use, laser dyes from Indeco Corporation such as Coumarin 460, Coumarin 480, Coumarin 481, Coumarin 485, Coumarin 487, Coumarin 490, LD 489, LD 490, Coumarin 500, Coumarin 503, Coumarin 504, Coumarin 504T, Coumarin 515; commercially available luminescent dyes such as Perylene, 9-amino-acridine, 12(9-anthroyoxy)stearic acid, 4-phenylspyro[furan-2(3H), 1′-futalan]-3,3′-dione, N-(7-dimethylamino-4-methylcoumarynyl)maleimide; dyes from American Dye Sources such as ADS135BE, ADS040BE, ADS256FS, ADS086BE, ADS084BE; or a combination of any of these, can be used.

The term “emission” means the emission of electromagnetic waves by electron transitions in atoms and molecules.

As organic light luminescent materials for green emission use, laser dyes from Indeco Corporation such as Coumarin 522/522B, Coumarin 525 or a combination of any of these can be used preferably.

As organic light luminescent materials for red emission use, laser dyes from Indeco Corporation such as DCM, Fluorol 555, Rhodamine 560 Perchlorate, Rhodamine 560 Chloride, LDS 698; dyes from American Dye Source Inc., such as ADS055RE, ADS061RE, ADS068RE, ADS069RE, ADS076RE or a combination of any of these, can be used in this way preferably.

According to the present invention, in some embodiments, one or more of red organic dyes together with one or more of green light emitting dyes which can convert UV light and/or blue light into green light, can be used for red emission use like described in JP 2003-264081 A.

As inorganic light luminescent materials, any kinds of commercially available inorganic fluorescent materials can be used as desired.

In a preferred embodiment of the invention, inorganic light luminescent materials is present and preferably selected from one or more members of the group consisting of sulfides, thiogallates, nitrides, oxynitrides, silicates, aluminates, apatites, borates, oxides, phosphates, halophosphates, sulfates, tungstenates, tantalates, vanadates, molybdates, niobates, titanates, germinates, halides based phosphors.

Suitable inorganic light luminescent materials described above are well known to the skilled person and mentioned e.g. in the phosphor handbook, 2^{nd} edition (CRC Press, 2006), pp. 155-pp. 338 (W. M. Yen, S. Shionoya and H. Yamamoto), WO2011/147517A, and WO2012/034625A.

More preferably, the said inorganic light luminescent materials have a medium size in the range from 1 nm to 100 nm. More particularly preferably, the medium size is in the range from 3 nm to 50 nm. The most preferably, from 5 nm to 25 nm.

For blue inorganic light luminescent materials, Cu activated zinc sulfide phosphors like described in Japanese patent application laid-open no. JP2002-062530 A, Eu activated halophosphate phosphors and/or Eu activated aluminate phosphors like described in JP 2006-299207 A, or a combination of any of these can be used preferably.

For green inorganic light luminescent materials, Ce or Tb activated rare earth element borate phosphors as described in JP 2006-299207 A, beta-sialon green phosphors described in JP 2007-262417 A, and a combination of any of these, can be used preferably.

For red inorganic light luminescent materials, Eu activated lanthanum sulfide phosphors, Eu activated yttrium sulfide phosphors described in JP 2006-299207 A, yellow phosphors which consist of BaS and Cu²⁺ as an emission site described in JP 2007-063365 A, red phosphors which consist of Ba₂ZnS₃ and Mn²⁺ described in JP 2007-063366 A, Ce activated garnet phosphors described in JP 3503139 B, red phosphors described in JP 2005-048105 A, Ca alpha-sialon red phosphors described in JP 2006-257353 A, or a combination of any of these, can be used preferably.

According to the present invention, the term “nano” means the size in between 1 nm and 999 nm.

Thus, according to the present invention, the term “nanosized light emitting material” is taken to mean that a light emitting material which size of the overall diameter is in the range from 1 nm to 999 nm. And in case of the nanosized light emitting material has non spherical shape, such as an elongated shape, the length of the overall structures of the nanosized light emitting material is in the range from 1 nm to 999 nm.

According to the present invention, the term “quantum sized” means the size of the semiconducting material itself without ligands or another surface modification, which can show the quantum confinement effect, like described in, for example, ISBN:978-3-662-44822-9.

Generally quantum sized materials, such as quantum dot materials and quantum rod materials, can emit tunable, sharp and vivid colored light due to “quantum confinement” effect.

Therefore, in a preferred embodiment of the present invention, the nanosized light emitting material is a quantum sized material.

In a preferred embodiment of the invention, the length of the overall structures of the quantum sized material is in the range from 1 nm to 100 nm. More preferably, it is from 2 nm to 20 nm, even more preferably, it is in the range from 3 nm to 10 nm.

In a preferred embodiment of the present invention, the nanosized light emitting material comprises II-VI, III-V, IV-VI semiconductors and combinations of any of these.

In case of the nanosized light emitting material does not have any core/shell structure, the semiconductor nanocrystal can preferably be selected from the group consisting of InP, CdS, CdSe, CdTe, ZnS, ZnSe, ZnSeS, ZnTe, ZnO, InPZnS, InPZn, Cu₂(ZnSn)S₄, ZnSeTe.

In a preferred embodiment of the present invention, the nanosized light emitting material comprise a core/shell structure.

According to the present invention, the term “core/shell structure” means the structure having a core part and at least one shell part covering said core.

In some embodiments of the present invention, said core/shell structure can be core/one shell layer structure, core/double shells structure or core/multishells structure.

According to the present invention, the term “multishells” stands for the stacked shell layers consisting of three or more shell layers.

Each stacked shell layers of double shells and/or multishells can be made from same or different materials.

More preferably, a core of the nanosized light emitting material (120) is selected from the group consisting of Cds, CdSe, CdTe, ZnS, ZnSe, ZnSeS, ZnTe, ZnO, GaAs, GaP, GaAs, GaSb, HgS, HgSe, HgSe, HgTe, InAs, InP, InPZnS, InPZn, InSb, AlAs, AlP, AlSb, Cu₂S, Cu₂Se, CuInS₂, CuInSe₂, Cu₂(ZnSn)S₄, Cu₂(InGa)S₄, TiO₂ alloys and combination of any of these.

In a preferred embodiment of the present invention, said shell is selected from the group consisting of II-VI, III-V, or IV-VI semiconductors.

For example, for red emission use CdSe/CdS, CdSeS/CdZnS, CdSeS/CdS/ZnS, ZnSe/CdS, CdSe/ZnS, InP/ZnS, InP/ZnSe, InP/ZnSe/ZnS, InPZn/ZnS, InPZn/ZnSe/ZnS dots or rods, ZnSe/CdS, ZnSe/ZnS or combination of any of these, can be used preferably.

For example, for green emission use CdSe/CdS, CdSeS/CdZnS, CdSeS/CdS/ZnS, ZnSe/CdS, CdSe/ZnS, InP/ZnS, InP/ZnSe, InP/ZnSe/ZnS, InPZn/ZnS, InPZn/ZnSe/ZnS, ZnSe/CdS, ZnSe/ZnS or combination of any of these can be used preferably.

And for blue emission use, such as ZnSe, ZnS, ZnSe/ZnS, or combination of any of these, can be used.

As a quantum dot, publically available quantum dot, for examples, CdSeS/ZnS alloyed quantum dots product number 753793, 753777, 753785, 753807, 753750, 753742, 753769, 753866, InP/ZnS quantum dots product number 776769, 776750, 776793, 776777, 776785, PbS core-type quantum dots product number 747017, 747025, 747076, 747084, or CdSe/ZnS alloyed quantum dots product number 754226, 748021, 694592, 694657, 694649, 694630, 694622 from Sigma-Aldrich, can be used preferably as desired.

In some embodiments, the semiconductor nanocrystal can be selected from an anisotropic shaped structure, for example quantum rod material to realize better out-coupling effect (for example ACS Nano, 2016, 10 (6), pp 5769-5781). Examples of quantum rod material have been described in, for example, the international patent application laid-open No.WO2010/095140A, Luigi Carbone et. al, Nanoletters, 2007, Vol. 7, No. 10, 2942-2950.

In a preferred embodiment of the present invention, the semiconductor nanocrystal additionally comprises a surface ligand.

The surface of the semiconductor nanocrystal can be over coated with one or more kinds of surface ligands.

Without wishing to be bound by theory it is believed that such surface ligands may lead to disperse the semiconductor nanocrystal in a solvent more easily.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines such as Dedecyl amine (DDA), Tetradecyl amine (TDA), Hexadecyl amine (HDA), and Octadecyl amine (ODA), thiols such as hexadecane thiol and hexane thiol; mercapto carboxylic acids such as mercapto propionic acid and mercaptoundecanoic acid; and a combination of any of these.

Examples of surface ligands have been described in, for example, the international patent application laid-open No. WO 2012/059931A.

### 1^{st} Organic Solvent

According to the present invention, as said 1^{st} organic solvent, any type of organic solvent having boiling point of 150° C. or more under atmospheric pressure can be used alone or as a mixture.

More preferably, said 1^{st} organic solvent is an organic solvent having boiling point in the range from 150° C. to 410° C. under atmospheric pressure. More preferably, it is in the range from 200° C. to 330° C. under atmospheric pressure to realize better viscosity of the formulation and the liquid surface tension of the formulation in addition to better solubility or better dispersity of the polymer/nanosized light emitting material.

In a preferred embodiment of the present invention, the 1^{st} organic solvent is selected from one or more members of the group consisting of alkyl chains having 9-25 carbon atoms, and alkenyl chains having 10-25 carbon atoms, ethylene glycol, triethylene glycol, glycerin, acetamide, dimethyl acetamide, dimethyl sulfoxide, trimethyl benzenes such as 1,3,5-trimethylbenzene, 1,2,4-trimethyl benzene, 1,2,3-trimethyl benzene, docecylbenzene, cyclohexylbenzene, 1,2,3,4-tetramethylbenzene, 1,2,3,5-tetramethylbenzene, 3-isopropylbiphenyl, 3-methylbiphenyl, 4-methylbiphenyl, p-anysyl alcohol, 1-methylnaphthalene, 1,2,3,4-tetrahydronaphthalene, hexyl alcohols, octanols, lauryl alcohols and their derivatives.

According to the present invention, the alkyl chain, or the alkenyl chain can be straight chain or branched chain, with preferably being of straight chain.

In some embodiments of the present invention, an alkyl chain having 9 to 25 carbon atoms or an alkenyl chain having 10 to 25 carbon atoms can be unsubstituted, mono- or polysubstituted by halogen or CN, it being also possible for one or more non-adjacent CH₂ groups to be replaced, in each occurrence independently from one another, by —O—, —S—, —NH—, —N(CH₃)—, —CO—, —COO—, —OCO—, —C—CO—O—, —S—CO—, —CO—S—, —CH═CH—, —CH═CF—, —CF═CF— or —C═C— in such a manner that oxygen atoms are not linked directly to one another.

In a preferred embodiment of the present invention, said alkyl chains having 9-25 carbon atoms, and alkenyl chains having 10-25 carbon atoms are unsubstituted.

In a more preferred embodiment of the present invention, said alkyl chain having 9-25 carbon atoms is Nonan (boiling point of 151° C.), Decan (boiling point of 174° C.), Undecan (boiling point of 196° C.), Dodecan (boiling point of 216° C.), Tridecan (boiling point of 235° C.), Tetradecan (boiling point of 254° C.), Pentadecan (boiling point of 270° C.), Hexadecan (boiling point of 287° C.), Heptadecan (boiling point of 302° C.), Octadecan (boiling point of 316° C.), Nonadecan (boiling point of 330° C.), Eicosan (boiling point of 343° C.), Heneicosan (boiling point of 357° C.), Docosan (boiling point of 369° C.), Tricosan (boiling point of 380° C.), Tetracosan (boiling point of 391° C.), or Pentacosan (boiling point of 402° C.), and said alkenyl chain having 10-25 carbon atoms is 1-decene (boiling point of 171° C.), 1-undecene, 1-dodecene, 1-tridecene, 1-tetradecene, 1-pentadecene, 1-hexadecene, 1-heptadecene, 1-octadecene, 1-nonadecene, 1-eicocene, 1-heneicosene, 1-dococene, 1-tricocene, 1-tetracocene, or 1-pentacocene.

In a preferred embodiment of the present invention, the 1^{st} organic solvent is selected from one or more of alkyl chains having 10 to 25 carbon atoms and/or alkenyl chains having 11 to 25 carbon atoms.

More preferably, the 1^{st} organic solvent is selected from one or more of alkyl chains having 12-19 carbon atoms, and/or alkenyl chains having 12-19 carbon atoms.

Even more preferably, the 1^{st} organic solvent is selected from one or more members of the group consisting of tridecan, tetradecane, pentadecane, hexadecane, heptadecan, and octadecane.

Without wishing to be bound by theory, it is believed that the 1^{st} organic solvent mentioned above prevents or reduces a convection of the formulation due to lower volatilization speed driven from a high boiling point of the 1^{st} organic solvent itself, when solvents in the formulation are drying up from the formulation.

According to the present invention, for example, propylene glycol monomethyl ether acetate (PGMEA: boiling point 145° C.) is not sufficient as the 1^{st} organic solvent since it has higher volatilization speed.

In other words, without wishing to be bound by theory, it is believed that such high boiling point of the 1^{st} organic solvent gives smaller evaporation rate of said solvent when drying the printed formulation and it prevents or reduces convection of the formulation.

### Polymer

According to the present invention, as a polymer, a wide variety of publically known one or more of polymers can be used preferably.

Especially, transparent polymers suitable for optical mediums such as optical devices can be used more preferably as the polymer.

According to the present invention, the term “transparent” means at least around 60% of incident light transmit at the thickness used in an optical medium and at a wavelength or a range of wavelength used during operation of an optical medium. Preferably, it is over 70%, more preferably, over 75%, the most preferably, it is over 80%.

According to the present invention the term “polymer” means a material having a repeating unit and having the weight average molecular weight (Mw) 1000 or more.

In a preferred embodiment of the present invention, the weight average molecular weight (Mw) of the polymer is in the range from 10,000 to 150,000.

More preferably it is in the range from 15,000 to 100,000 to give suitable viscosity to said formulation and to give suitable strength of polymer after fabrication.

Without wishing to be bound by theory, it is believed that the polymer having the weight average molecular weight (Mw) in the range mentioned above prevents or reduces a convection of formulation when solvents in the formulation are drying up from the formulation.

Without wishing to be bound by theory, it is believed that the combination of 1^{st} organic solvent having a boiling point of 150° C. or more, and the polymer is highly effective to prevent or reduce a convection of formulation when solvents in the formulation are drying up from the formulation and to prevent phenomena of moving nanosized light emitting material to the edge of printed pattern.

According to the present invention, the molecular weight Mw can be determined by means of GPC (=gel permeation chromatography) against an internal polystyrene standard.

As a polymer, in some embodiments, one or more of electrically conductive polymers can be used.

In a preferred embodiment of the present invention the transparent polymer is selected from one or more members of the group consisting of organic electron transporting polymers, organic electron blocking polymers, cyclo olefin copolymers, polyvinyl alcohols, polystyrenes, polyamides such as nylon, polymethyl methacrylate, polyacrylonitriles, and ethylene vinyl alcohols.

More preferably, the polymer is a polystyrene, or a nylon.

If case of the transparent polymer is a cyclo olefin copolymer, the 1st organic solvent can be selected from one or more of alkyl chains having 10 to 25 carbon atoms and/or alkenyl chains having 11 to 25 carbon atoms more preferably.

In case of the transparent polymer is one selected from one or more of members of the group consisting of polyvinyl alcohols, polyacrylonitriles, and ethylene vinyl alcohols, then, the 1st organic solvent can be selected from one or more of the group consisting of ethylene glycol, triethylene glycol, glycerin, acetamide, dimethyl acetamide, dimethyl sulfoxide more preferably.

### 2^{nd} Organic Solvent

According to the present invention, in some embodiments, the formulation can further comprise 2^{nd} organic solvent having a boiling point in the range from 30° C. to 400° C.

For example, said 2^{nd} organic solvent can be selected from the group consisting of purified/deionized water; ethylene glycol monoalkyl ethers, such as, ethylene glycol monomethyl ether, ethylene glycol monoethyl ether, ethylene glycol monopropyl ether, and ethylene glycol monobutyl ether; diethylene glycol dialkyl ethers, such as, diethylene glycol dimethyl ether, diethylene glycol diethyl ether, diethylene glycol dipropyl ether, and diethylene glycol dibutyl ether; ethylene glycol alkyl ether acetates, such as, methyl cellosolve acetate and ethyl cellosolve acetate; propylene glycol alkyl ether acetates, such as, propylene glycol monomethyl ether acetate (PGMEA), propylene glycol monoethyl ether acetate, and propylene glycol monopropyl ether acetate; ketones, such as, methyl ethyl ketone, acetone, methyl amyl ketone, methyl isobutyl ketone, and cyclohexanone; alcohols, such as, ethanol, propanol, butanol, hexanol, cyclo hexanol, ethylene glycol, and glycerin; esters, such as, ethyl 3-ethoxypropionate, methyl 3-methoxypropionate and ethyl lactate; and cyclic asters, such as, γ-butyro-lactone; chlorinated hydrocarbons, such as chloroform, dichloromethane, chlorobenzene, dichlorobenzene, trimethyl benzenes such as 1,3,5-trimethylbenzene, 1,2,4-trimethyl benzene, 1,2,3-trimethyl benzene, docecylbenzene, cyclohexylbenzene, 1,2,3,4-tetramethylbenzene, and 1,2,3,5-tetramethylbenzene.

Those solvents can be used singly or in combination of two or more if applicable.

In a preferred embodiment of the present invention, the boiling point of the 2^{nd} organic solvent is in the range from 150° C. to 330° C.

More preferably, the 2^{nd} organic solvent is selected from one or more members of the group consisting of, trimethyl benzenes such as 1,3,5-trimethylbenzene, 1,2,4-trimethyl benzene, 1,2,3-trimethyl benzene, docecylbenzene, cyclohexylbenzene, 1,2,3,4-tetramethylbenzene, and 1,2,3,5-tetramethylbenzene to disperse said nanosized light emitting material into said formulation well and to more precisely control the absolute viscosity of the formulation and the liquid surface tension of the formulation.

According to the present invention, said 2^{nd} organic solvent is different from said 1^{st} organic solvent.

### Another Additives

In some embodiments of the present invention, optionally, the formulation can further comprise one or more of another compound. Preferably it is selected from one or more members of the group consisting of surfactants, organic light luminescent materials, host materials, electron transporting materials, and inorganic light luminescent materials.

As host materials, electron transporting materials, publically available materials can be used as desired.

### Optical Medium

In another aspect, the present invention further relates to an optical medium comprising at least a substrate including an array of pixels filled with at least a polymer, and a first particle, obtained or obtainable from the method of the present invention.

In some embodiments of the present invention, the optical medium comprises an anode and a cathode, and at least one organic layer comprising at least one first particle and the polymer of the present invention, more preferably the medium further comprises one or more layers selected from the group consisting of hole injection layers, hole transporting layers, electron blocking layers, hole blocking layers, electron blocking layers, and electron injection layers.

In some embodiments of the present invention, the organic layer comprises at least one light emitting nanoparticle and a polymer, preferably the polymer is an organic host material.

According to the present invention, any kinds of publicly available inorganic, and/or organic materials for hole injection layers, hole transporting layers, electron blocking layers, light emission layers, hole blocking layers, electron blocking layers, and electron injection layers can be used preferably, like as described in WO 2018/024719 A1, US2016/233444 A2, U.S. Pat. No. 7,754,841 B, WO 2004/037887 and WO 2010/097155.

The type of polymer and the first particle are described in the section of “Polymer” and in the section of “First particle” above.

In general, substrate can be flexible, semi-rigid or rigid.

Publically known substrate suitable for optical devices can be used as desired, preferably said substrate is a transparent.

Preferably, as a transparent substrate, a transparent polymer substrate, glass substrate, thin glass substrate stacked on a transparent polymer film, transparent metal oxides (for example, oxide silicone, oxide aluminum, oxide titanium), is used.

A transparent polymer substrate can be made from polyethylene, ethylene-vinyl acetate copolymer, ethylene-vinyl alcohol copolymer, polypropylene, polystyrene, polymethyl methacrylate, polyvinylchloride, polyvinyl alcohol, polyvinylvutyral, nylon, polyether ether ketone, polysulfone, polyether sulfone, tetrafluoroethylene-erfluoroalkylvinyl ether copolymer, polyvinyl fluoride, tetraflyoroethylene ethylene copolymer, tetrafluoroethylene hexafluoro polymer copolymer, or a combination of any of these.

The term “transparent” means at least around 60% of incident light transmittal at the thickness used in a photovoltaic device and at a wavelength or a range of wavelength used during operation of photovoltaic cells. Preferably, it is over 70%, more preferably, over 75%, the most preferably, it is over 80%.

In some embodiments of the present invention, the array of pixels comprises a 1^{st} organic solvent in the range from 0.001 wt. % to 1 wt. % based on total amount of the polymer and the first particle in the array of pixels.

In some embodiments of the present invention, the optical medium can be an optical film, for example, a color filter, color conversion film, remote phosphor tape, or another film or filter.

### Optical Device

In another aspect, the invention further relates to an optical device comprising the optical medium.

In some embodiments of the present invention, the optical device can be a liquid crystal display (LCD), Organic Light Emitting Diode (OLED), backlight unit for display, Light Emitting Diode (LED), Micro Electro Mechanical Systems (here in after “MEMS”), electro wetting display, or an electrophoretic display, or a lighting device.

### Fabrication Process

In another aspect, the present invention furthermore relates to process for preparing of the formulation of the present invention, wherein the method comprising following step (a),

(a) mixing at least a 1^{st} organic solvent having a boiling point of 150° C. or more, a polymer, and a first particle.

Preferably, step (a) is carried out at a room temperature under inert condition such as under N₂ condition.

In another aspect, the present invention also relates to method for preparing of an optical medium, wherein the method comprises at least following steps (A) and (B) in this sequence,
(A) providing the formulation of the present invention onto a substrate,
(B) removing the 1^{st} organic solvent from the formulation.

Preferably, all steps are carried out under inert condition such as under N₂ condition.

In some embodiments of the present invention, said substrate comprises at least an anode or a cathode, and/or one or more layers selected from one or more members of the group consisting of hole injection layers, hole transporting layers, electron blocking layers, hole blocking layers, electron blocking layers, and electron injection layers.

Printing method in step (A) to provide the formulation is not particularly limited.

An inkjet printing method, or a nozzle printing method is preferably used. More preferably, an inkjet printing method is used for a pattern printing.

In step (B), in some embodiments of the present invention, a clean oven or a hot plate can be used.

From the view point of preventing or reducing a convection of the formulation when the solvent in the formulation is drying up from the formulation, temperature in step (B) can be set in the range from plus 10° C. to the boiling point of the 1^{st} organic solvent to 25° C.

### Effect of the Invention

The present invention provides;

an improved homogeneous layer or pattern after drying of a formulation comprising at least a first particle, preferably said layer or pattern is a light luminescent layer or pattern, preventing or reducing phenomena of moving a first particle to the edge of printed pattern when printing and drying of said formulation, smooth printing of the formulation, better dispersibility of a first particle(s) in said formulation, preferably better dispersibility of scattering particles and/or light emitting particles, simple fabrication process for making a pattern including a polymer and a first particle, preferably said pattern and/or formulation includes a polymer, scattering particles and/or light emitting particles, higher loading of scattering particles and/or light emitting particles in said formulation, or layer or pattern.

The working examples 1-3 below provide descriptions of the present invention, as well as an in-detail description of their fabrication.

### WORKING EXAMPLES

### Working Example 1: Preparation of Formulation

Nanocrystals having InP core and ZnSe shell are dispersed in toluene by immobilization of tri-n-octylphosphine oxide(TOPO) on their surface. Nanocrystals/toluene dispersion is evaporated by using an evaporator to evaporate toluene. After drying nanocrystals/toluene dispersion, cyclohexylbenzene(CHB) is added and sonicated to make nanocrystal/CHB dispersion fluid. A weight ratio of nanocrystal is 10 wt. %. 3 ml of CHB, 0.03 g of TiO2, and 0.01 g of polystyrene(PS) are mixed and sonicated by using a tip sonicator for 2 minutes. 7 ml of nanocrystal/CHB dispersion fluid is mixed with 3 ml of TiO2/PS/CHB dispersion fluid described before, and sonicated. TiO2 beads are well dispersed in nanocrystals/CHB fluid.

### Working Example 2: Preparation of Formulation

Nanocrystals having InP core and ZnSe shell are dispersed in toluene by immobilization of tri-n-octylphosphine oxide(TOPO) on their surface. Nanocrystals/toluene dispersion is evaporated by using an evaporator to evaporate toluene. After drying nanocrystals/toluene dispersion, cyclohexylbenzene(CHB) is added and sonicated to make nanocrystal/CHB dispersion fluid. A weight ratio of nanocrystal is 10 wt. %. 3 ml of CHB, 0.03 g of TiO2, and 0.01 g of PMMA are mixed and sonicated by using a tip sonicator for 2 minutes. 7 ml of nanocrystal/CHB dispersion fluid is mixed with 3 ml of TiO2/PS/CHB dispersion fluid described before, and sonicated. TiO2 beads are well dispersed in nanocrystals/CHB fluid.

### Working Example 3: Preparation of Formulation

Nanocrystals having InP core and ZnSe shell are dispersed in toluene by immobilization of tri-n-octylphosphine oxide(TOPO) on their surface. Nanocrystals/toluene dispersion is evaporated by using an evaporator to evaporate toluene. After drying nanocrystals/toluene dispersion, cyclohexylbenzene(CHB) is added and sonicated to make nanocrystal/CHB dispersion fluid. A weight ratio of nanocrystal is 10 wt. %. 3 ml of CHB, 0.03 g of TiO2, and 0.01 g of nylon are mixed and sonicated by using a tip sonicator for 2 minutes. 7 ml of nanocrystal/CHB dispersion fluid is mixed with 3 ml of TiO2/PS/CHB dispersion fluid described before, and sonicated. TiO2 beads are well dispersed in nanocrystals/CHB fluid.

1. A formulation comprising at least a polymer, a first particle, and a 1^{st} organic solvent having a boiling point of 150° C. or more.

2. The formulation according to claim 1, wherein the absolute viscosity of the formulation is in the range from 1 mPa·s to 20 mPa·s.

3. The formulation according to claim 1, wherein the liquid surface tension of the formulation is in the range from 10 mN/m to 60 mN/m.

4. The formulation according to claim 1, wherein the molecular weight of the polymer is in the range from 10,000-150,000.

5. The formulation according to claim 1, wherein the polymer is selected from any member of the group consisting of organic electron transporting polymers, organic electron blocking polymers, cyclo olefine copolymers, polyvinyl alcohols, polystyrenes, polyamides such as nylon, polymethyl methacrylate, polyacrylonitriles, and ethylene vinyl alcohols.

6. The formulation according to claim 1, wherein the polymer is a nylon, or a polystyrene.

7. The formulation according to claim 1, wherein the 1^{st} organic solvent is selected from the group consisting of alkyl chains having 9-25 carbon atoms, and alkenyl chains having 10-25 carbon atoms, ethylene glycol, triethylene glycol, glycerin, acetamide, dimethyl acetamide, dimethyl sulfoxide, trimethyl benzenes such as 1,3,5-trimethylbenzene, 1,2,4-trimethyl benzene, 1,2,3-trimethyl benzene, docecylbenzene, cyclohexylbenzene, 1,2,3,4-tetramethylbenzene, 1,2,3,5-tetramethylbenzene, 3-isopropylbiphenyl, 3-methylbiphenyl, 4-methylbiphenyl, p-anisyl alcohol, 1-methylnaphthalene, 1,2,3,4-tetrahydronaphthalene, hexyl alcohols, octanols, lauryl alcohols, preferably said alkyl chain is an alkyl chain having 10 to 25 carbon atoms and the alkenyl chain is an alkenyl chain having 11 to 25 carbon atoms.

8. The formulation according to claim 1, wherein the first particle is a light scattering particle or a light emitting particle.

9. The formulation according to claim 1, wherein the first particle is a light scattering particle and the formulation further comprises a light emitting particle.

10. The formulation according to claim 1, wherein the formulation comprises a 2^{nd} organic solvent having a boiling point in the range from 30° C. to 400° C., preferably from 150° C. to 330° C.

11. The formulation according to claim 10, wherein the 2^{nd} organic solvent is selected from the group consisting of hydrocarbons having 5-25 carbon atoms, glycols, acetamides, and dimethyl sulfoxide.

12. (canceled)

13. A process for preparing of the formulation according to claim 1, wherein the process comprises at least step (a),
(a) mixing at least a 1^{st} organic solvent having a boiling point of 150° C. or more, a polymer, and a first particle.

14. A process for preparing of an optical medium, wherein the process comprises at least following steps (A) and (B),
(A) providing the formulation according to claim 1, onto a substrate,
(B) removing the 1^{st} organic solvent from the formulation.

15. An optical medium comprising at least a substrate, a polymer, and a first particle, obtained by the process of claim 14, preferably said substrate includes an array of pixels filled with at least a polymer, and a first particle.

16. An optical device comprising at least one medium of claim 15.

17. A method for preparing an optical device which comprises:
(A) providing the formulation according to claim 1, onto a substrate,
(B) removing the 1^{st} organic solvent from the formulation to prepare an optical medium, and
(C) fabricating the optical device incorporating the optical medium.
